(19) United States
(12) Patent Application Publication
(10) Pub. No.: US 2017/0155147 A1
(43) Pub. Date: Jun. 1, 2017

(54) PREPARATION METHOD OF NICKEL-LITHIUM METAL COMPOSITE OXIDE

(71) Applicant: CS Energy Materials Ltd., Tokyo (JP)

(72) Inventors: Miwako NISHIMURA, Kumamoto (JP); Tomomi FUKUURA, Kumamoto (JP); Hiroaki ISHIZUKA, Kumamoto (JP); Hironori ISHIGURO, Kumamoto (JP)

(73) Assignee: CS Energy Materials Ltd., Tokyo (JP)

(21) Appl. No.: 15/364,210

(22) Filed: Nov. 29, 2016

(30) Foreign Application Priority Data
Nov. 30, 2015 (JP) 2015-233364

(51) Int. Cl. H01M 4/525; C01G 53/00; H01M 10/0525

(52) U.S. Cl. CPC H01M 4/525; H01M 10/0525; C01G 53/42; H01M 2004/028

(57) ABSTRACT

The disclosure realize high performance and reduction in cost of a lithium ion battery positive electrode active material. A preparation method of a nickel-lithium metal composite oxide represented by Formula LiₐNi_{1-x-y}CoₓM_{y}O_{b}, including a mixing step of raw materials and a precursor with each other, a low-temperature firing step of performing the firing at a temperature lower than a melting point of lithium carbonate, and a high-temperature firing step of performing the firing at a temperature equal to or higher than a melting point of lithium carbonate. Granular nickel-lithium metal composite oxide without aggregation or fixation are obtained immediately after the firing.

### CROSS-REFERENCE TO RELATED APPLICATION

This application claims the priority benefit of Japan application serial no. 2015-233364, filed on Nov. 30, 2015. The entirety of the above-mentioned patent application is hereby incorporated by reference herein and made a part of this specification.

### TECHNICAL FIELD

The present invention relates to a preparation method of a nickel-lithium metal composite oxide, a nickel-lithium metal composite oxide obtained by using the preparation method, a positive electrode active material formed thereof, a lithium ion battery positive electrode using the positive electrode active material, and a lithium ion battery.

### BACKGROUND ART

Information terminal devices capable of being portably used outdoors, such as personal computers or mobile phones have spread significantly in accordance with the introduction of light and small-sized batteries having high capacity. A demand for batteries to be mounted on a vehicle exhibiting high performance and having high safety or durability has increased along the spreading of hybrid vehicles. In addition, electric cars have also been realized along with realization of a small size and high capacity for batteries to be mounted. Many corporations and research institutes have already started technological development of batteries to be mounted on information terminal devices or vehicles and there is intense competition therebetween. Lithium ion batteries with a lower cost are currently in strong demand along with the intensification of market competition regarding information terminal devices, hybrid cars, or EV cars, and the balance between the quality and the cost is the issue.

First, reduction in costs of members or materials configuring a product may be considered as means for decreasing manufacturing costs of a final industrial product. In lithium ion batteries, reduction in costs may also be considered in regards to a positive electrode, a negative electrode, an electrolyte, and a separator which are essential elements thereof. Among these, the positive electrode is a member in which a lithium-containing metal oxide called a positive electrode active material is disposed on an electrode. The reduction in cost of the positive electrode active material is essential for the reduction in cost of the positive electrode and the reduction in cost of the batteries.

Attention is currently focused on nickel-based active materials expected to have a high capacity as a positive electrode active material of a lithium ion battery. A composite metal oxide containing cobalt and aluminum in addition to lithium and nickel (LNCAO) is a typical example of a nickel-based active material. As a lithium source of a nickel-based active material such as LNCAO, lithium hydroxide is used.

The inventor has already proposed LNCAO-based lithium ion battery positive electrode active materials using lithium hydroxide as a raw material and preparation methods thereof in Japanese Patent Application Nos. 2014-174149, 2014-174150, and 2014-174151. In a firing step of the preparation methods, a composite oxide of lithium and nickel (LNO) is generated by a reaction between nickel hydroxide and lithium hydroxide as main raw materials represented by the following formula.

(Preparation of LNO Using Nickel Hydroxide and Lithium Hydroxide as Raw Materials)

4Ni(OH)₂+4LiOH+O₂→4LiNiO₂+6H₂O

Here, the nickel-based active material represented by LNCAO is prepared using lithium hydroxide as a lithium source. For lithium hydroxide, a material obtained by industrial synthesis with a reaction represented by the following formula by using lithium carbonate as a raw material is solely used. The cost of the lithium hydroxide is, of course, higher than the cost of lithium carbonate which is a raw material thereof.

(Preparation of Lithium Hydroxide Using Lithium Carbonate as a Raw Material)

Li₂CO₃(aqueous solution)+Ca(OH)₂(aqueous solution)→2LiOH(aqueous solution)+CaCO₃(solid)

As described above, demand for realization of high performance and reduction in cost of lithium ion batteries has increased and it is necessary to realize high performance and reduction in costs of members of lithium ion batteries and materials configuring the members. It is also necessary to realize high performance and reduction in cost of the positive electrode active material containing LNO in the same manner as described above.

It is expected that there would be a decrease in manufacturing costs of the positive electrode active material containing LNO, with the synthesis of LNO from lithium carbonate (Li₂CO₃) having a lower cost. It is theoretically possible for a decomposition reaction of lithium carbonate to a lithium oxide and/or a lithium hydroxide and a reaction between a lithium oxide and/or a lithium hydroxide and a nickel compound to occur consistently. A series of the reactions is possible at a higher temperature at which a decomposition reaction of lithium carbonate to a lithium oxide and/or a lithium hydroxide can occur.

However, in the preparation of the positive electrode active material for lithium ion batteries, lithium carbonate is used as a lithium source, in a case of cobalt-based, manganese-based, or nickel-cobalt-manganese ternary system (NCM) active materials (Non Patent Document 1 and Patent Document 4). Lithium cobalt oxide (LCO) as a typical example of a cobalt-based positive electrode active material can be prepared by mixing lithium carbonate as a raw material with a cobalt oxide and/or a cobalt hydroxide and allowing synthesis at a firing temperature of approximately 1000° C. It is thought that a decomposition reaction of lithium carbonate to a lithium oxide and/or a lithium hydroxide occurs during this synthesis process. In a case of NCM, it is necessary to increase a firing temperature to a temperature close to a decomposition temperature of lithium carbonate, and accordingly, NCM is prepared by performing the firing at a high temperature of equal to or higher than 900° C.

Patent Document 5 discloses an example of using lithium hydroxide and lithium carbonate together as a lithium source. The preparation method disclosed in Patent Document 5 is a method of spraying, drying, and firing a slurry containing a manganese compound, a cobalt compound, a nickel compound, and lithium compounds to prepare a lithium-transition metal composite oxide. In this method, the lithium compounds include lithium hydroxide and lithium carbonate, a proportion of Li atoms derived from the lithium carbonate with respect to the entirety of Li atoms being 5 mol % to 95 mol %. The method includes spraying and drying the slurry, holding the slurry at a temperature of equal to or higher than 600° C. and lower than a melting point (723° C.) of lithium carbonate, and performing firing at a temperature of equal to or higher than the melting point of lithium carbonate.

As described above, a preparation example of a nickel-based active material (typically, LNO) using lithium carbonate as the only lithium source is not known. The reason that such a preparation method is difficult to perform may be because a layer structure of a LNO type composite oxide is unstable, unlike a layer structure of other positive electrode active materials for lithium ion batteries such as a cobalt-based active material. Since the thermodynamic energy of a reaction system increases in a reaction at a high temperature, a crystal structure of various composite oxides generated may be disturbed. Specifically, a state where ion exchange occurs at 3a sites (layer of lithium ions) and 3b sites (layer of nickel ions) of the layer structure of LNO due to thermal vibration at a high temperature to cause penetration of nickel into the lithium layer and penetration of lithium into the nickel layer, that is so-called cation mixing is caused. Accordingly, it is assumed that the performance of the obtained positive electrode active material is decreased and thus, only positive electrode active materials having overall low practicality are obtained. Since such an assumption would be persuasive to a person skilled in the art, a preparation method using lithium carbonate as a raw material for a LNO type composite oxide for lithium ion battery positive electrode active materials has not been investigated so far.

The applicant challenged such limitation of technology of the related art and investigated a preparation method of a LNO type positive electrode active material using only lithium carbonate as a lithium source that was considered to be impossible in the related art. As a result, it was found that it is possible to prepare a positive electrode active material for a lithium ion battery exhibiting a performance satisfying that demanded, by performing the firing step in two stages of a high-temperature firing step and a low-temperature firing step, and the application for a patent has already been made (Patent Document 6).

However, in a preparation method disclosed in Patent Document 6, a reaction efficiency was decreased due to melting lithium carbonate in a firing step. In addition, since nickel-lithium metal composite oxide particles obtained by cooling a fired product are strongly bound to each other through unreacted lithium carbonate, it was necessary to crush and finely pulverize the particles with a strong force in order to use the particles in a positive electrode mixture, and this caused complicated preparation steps. Further, fine powder due to excessive crushing of secondary particles may be generated and battery characteristics thus deteriorate.

### RELATED ART DOCUMENT

### Patent Document

[Patent Document 1] Japanese Patent Application No. 2014-174149
[Patent Document 2] Japanese Patent Application No. 2014-174150
[Patent Document 3] Japanese Patent Application No. 2014-174151
[Patent Document 4] Pamphlet of International Publication No. WO2009/060603
[Patent Document 5] JP-A-2005-324973
[Patent Document 6] Japanese Patent Application No. 2014-244059

### Non Patent Document

[Non Patent Document 1] Japan Oil, Gas and Metals National Corporation, Annual Report 2012, p. 148 to 154
[Non Patent Document 2] “Monthly Fine Chemical” November 2009, p. 81 to 82, CMC Publishing Co., Ltd.

### SUMMARY OF THE INVENTION

### Problem that the Invention is to Solve

As described above, the preparation method of a nickel-based positive electrode active material for lithium ion batteries using lithium carbonate as the only lithium source is not sufficiently investigated and there is sufficient room for further improvement. Therefore, the inventor has further improved a nickel-based positive electrode active material using lithium carbonate as a raw material and a preparation method thereof in order to realize high performance and reduction in cost of a lithium ion battery positive electrode active material.

That is, the inventor has made intensive research for obtaining a preparation method of an easily-operable nickel-lithium metal composite oxide with which performance of a positive electrode active material can be maintained and a rigid aggregate is not formed, even in a case where lithium carbonate is used as a lithium source.

### Means for Solving the Problem

As a result, the inventor has succeeded in controlling the binding of the fired and cooled nickel-lithium metal composite oxide powder with lithium carbonate by performing the firing under the special conditions, even in a case where lithium carbonate is used as the only lithium source, and preparing the nickel-lithium metal composite oxide powder for which it is not necessary to perform excessive crushing that easily causes generation of a fine powder.

That is, the invention is as follows.

(Invention 1) A preparation method of a nickel-lithium metal composite oxide represented by the following Formula (1), including the following Step 1 and/or Step 1′, Step 2, and Step 3.

LiₐNi_{1-x-y}CoₓM_{y}O_{b} (1)

(In Formula (1), relationships of 0.90<a<1.10, 1.7<b<2.2, 0.01<x<0.15, and 0.005<y<0.10 are satisfied, M represents metals which include Al as an essential element and may include elements selected from Mn, W, Nb, Mg, Zr, and Zn.)

(Step 1) A mixing step of mixing a hydroxide or an oxide of a metal M and lithium carbonate, with a precursor configured with at least one selected from a nickel hydroxide, a nickel oxide, a cobalt hydroxide, and a cobalt oxide to obtain a mixture.

(Step 1′) A mixing step of mixing lithium carbonate, with a precursor including a nickel hydroxide, a nickel oxide, a cobalt hydroxide or a cobalt oxide, and a hydroxide or an oxide of a metal M to obtain a mixture.

(Step 2) A low-temperature firing step of firing the mixture obtained in Step 1 or Step 1′ at a temperature lower than a melting point of lithium carbonate to obtain a fired product.

(Step 3) A high-temperature firing step of firing the fired product passed through Step 2 at a temperature equal to or higher than a melting point of lithium carbonate to obtain a fired product.

(Invention 2) The preparation method of a nickel-lithium metal composite oxide according to Invention 1, in which the firing is performed in a temperature range of equal to or higher than 400° C. and lower than 723° C. in Step 2, and the firing is performed in a temperature range of 723° C. to 850° C. in Step 3.

(Invention 3) The preparation method of a nickel-lithium metal composite oxide according to Invention 1 or Invention 2, in which a continuous furnace or a batch furnace is used in Step 2 and/or Step 3.

(Invention 4) The preparation method of a nickel-lithium metal composite oxide according to any one of Inventions 1 to 3, in which a firing furnace selected from a rotary kiln, a roller hearth kiln, and a muffle furnace is used in Step 2 and/or Step 3.

(Invention 5) The preparation method of a nickel-lithium metal composite oxide according to any one of Inventions 1 to 4, in which a nickel-lithium metal composite oxide fired product, an amount of which does not pass through a standard sieve having a nominal opening size of 1.00 mm defined based on JIS Z 8801-1:2006 is equal to or smaller than 1% by weight, is obtained from Step 3.

(Invention 6) The preparation method of a nickel-lithium metal composite oxide according to any one of Inventions 1 to 5, further including: a step of crushing the fired product obtained in Step 3 and/or a step of sieving the fired product passed through Step 3, after Step 3.

(Invention 7) A nickel-lithium metal composite oxide powder which is a nickel-lithium metal composite oxide powder represented by the following Formula (1),

LiₐNi_{1-x-y}CoₓM_{y}O_{b} (1)
(in Formula (1), relationships of 0.90<a<1.10, 1.7<b<2.2, 0.01<x<0.15, and 0.005<y<0.10 are satisfied, M represents metals which include Al as an essential element and may include elements selected from Mn, W, Nb, Mg, Zr, and Zn)
in which the nickel-lithium metal composite oxide powder functions as a lithium ion battery positive electrode active material,
   in which an amount of the nickel-lithium metal composite oxide powder which does not pass through a standard sieve having a nominal opening size of 1.00 mm defined based on JIS Z 8801-1:2006 is equal to or smaller than 1% by weight,
   a concentration of hydrogen ions in a supernatant when 2 g of the nickel-lithium metal composite oxide powder is dispersed in 100 g of water is equal to or smaller than 11.70 in terms of pH,
   a 0.1 C discharge capacity of a lithium ion battery including a positive electrode including a coating film dried product from a positive electrode active material mixture containing the nickel-lithium metal composite oxide powder, carbon black, and a binder, and a negative electrode formed of lithium metal is equal to or greater than 180 mAh/g, and
   an initial charging and discharging efficiency of a lithium ion battery including a positive electrode including a coating film dried product from a positive electrode active material mixture containing the nickel-lithium metal composite oxide powder, carbon black, and a binder, and a negative electrode formed of lithium metal is equal to or greater than 83%.

(Invention 8) The nickel-lithium metal composite oxide powder according to Invention 7, which is a powder immediately after performing the firing, without performing neither of a crushing treatment with a pulverizing device or a crushing device and sieving.

(Invention 9) The nickel-lithium metal composite oxide powder according to Invention 7 or 8, which is a material obtained by using the preparation method of a nickel-lithium metal composite oxide according to any one of Inventions 1 to 6.

(Invention 10) A positive electrode active material including: the nickel-lithium metal composite oxide powder according to Invention 8 or 9.

(Invention 11) A positive electrode mixture for a lithium ion battery including: the positive electrode active material according to Invention 10.

(Invention 12) A positive electrode for a lithium ion battery using the positive electrode mixture for a lithium ion battery according to Invention 11.

(Invention 13) A lithium ion battery including: the positive electrode for a lithium ion battery according to Invention 12.

### Advantage of the Invention

In the invention, the firing step is performed in two stages. The first firing (low-temperature firing step) is performed at a temperature lower than the melting point (723° C.) of the lithium carbonate, and the second firing (high-temperature firing step) is performed at a temperature equal to or higher than the melting point of the lithium carbonate. The effective firing step of performing the firing at a low temperature as described above is a surprising discovery.

It can be assumed that the reaction occurs in the following route, in a case of preparing a nickel-lithium metal composite oxide using lithium carbonate as a lithium source. That is, as shown with the following reaction formula, the lithium carbonate is first pyrolyzed to generate a lithium oxide (Li₂O) and this lithium oxide is hydrated to generate a lithium hydroxide (LiOH).

Li₂CO₃→2Li₂O+CO₂

Li₂O+H₂O→2LiOH

Next, as shown with the following reaction formula, the lithium oxide (Li₂O) or the lithium hydroxide (LiOH) generated as descried above reacts with a nickel hydroxide and a lithium-nickel metal composite oxide is formed.

Li₂O+2Ni(OH)₂+1/2O₂→2LiNiO₂+2H₂O↑

or

2LiOH+2Ni(OH)₂+1/2O₂→2LiNiO₂+3H₂O↑

Accordingly, it is assumed that a lithium oxide and/or lithium carbonate is generated in a temperature range where lithium carbonate is pyrolyzed and a reaction between the lithium oxide and/or the lithium carbonate and a transition metal such as nickel continuously proceeds in an equilibrium reaction manner.

Here, the behavior of the lithium carbonate along the temperature rising will be described. FIG. 1 shows a thermogravimetric analysis result (TG) in a case where lithium carbonate is fired. As shown in FIG. 1, the weight of the lithium carbonate decreases in a temperature range of equal to or higher than 700 which is close to a melting point thereof. FIG. 2 shows a temperature change in the firing of the lithium carbonate and a concentration of carbon dioxide in exhaust gas generated, along the firing time. As shown in FIG. 2, rapid generation of carbon dioxide is observed when the temperature reached approximately 700° C. and approximately 4 or 5 hours have elapsed.

In the related art, it was considered that it was necessary to maintain the temperature in a temperature range sufficiently higher than a pyrolysis starting temperature, for example, approximately 800° C. in the firing step of the nickel-lithium metal composite oxide for a positive electrode active material, based on the knowledge about the pyrolysis reaction of the lithium carbonate.

However, it was found that, when the time for performing the firing at a comparatively low temperature, that is, a temperature range lower than the melting point (723° C.) of the lithium carbonate is provided in the firing step, the binding of particles due to the melted lithium carbonate is avoided and a reaction between a pyrolysate of the lithium carbonate and a transition metal such as nickel proceeds so as to synthesize finally desired nickel-lithium metal composite oxide.

Such temperature setting in the firing step of the invention seems to be against the knowledge in the related art. In a case where the lithium carbonate and other metal compounds such as a transition metal are fired in a state of coexistence, the behavior of the lithium carbonate may be largely different from that in a case of the firing the lithium carbonate alone. With some complex reasons, the pyrolysis of the lithium carbonate is actually started in a temperature range which was considered as an excessively low temperature range as the firing temperature in the related art. Accordingly, in the firing step of the invention, the pyrolysis of the lithium carbonate is caused to proceed without accumulating the melted lithium carbonate causing particles binding or a decrease in reaction efficiency, so as to complete the reaction between the lithium compound and the nickel compound.

In the preparation method of the nickel-lithium metal composite oxide of the invention, fine particles of lithium-nickel metal composite oxide, an amount of which remaining on a sieve when sieving is performed with a sieve having a nominal opening size of 1.00 mm among standard sieves defined based on JIS Z 8801-1:2006 is equal to or smaller than 1% by weight, are obtained through the firing step. The nickel-lithium metal composite oxide of the invention exhibits excellent operatability.

In the preparation method of the lithium nickel metal composite oxide of the invention, lithium carbonate which is more inexpensive than a lithium hydroxide is solely used as a lithium source in the related art. Accordingly, the manufacturing costs of the nickel-lithium metal composite oxide of the invention is significantly reduced. In addition, surprisingly, the performance of the positive electrode active material obtained with the preparation method of the invention is equivalent to or better than the performance of the positive electrode active material obtained by the method of the related art.

As described above, the invention provides a nickel-based positive electrode active material exhibiting excellent performance as a positive electrode active material without rigid aggregating at a low cost, by using lithium carbonate as the only lithium source and using special firing conditions.

### BRIEF DESCRIPTION OF THE DRAWINGS

FIG. 1 shows a thermogravimetric analysis result of lithium carbonate.

FIG. 2 shows a temperature in a case of performing the firing of the lithium carbonate alone and a concentration of carbon dioxide in exhaust gas along the firing time.

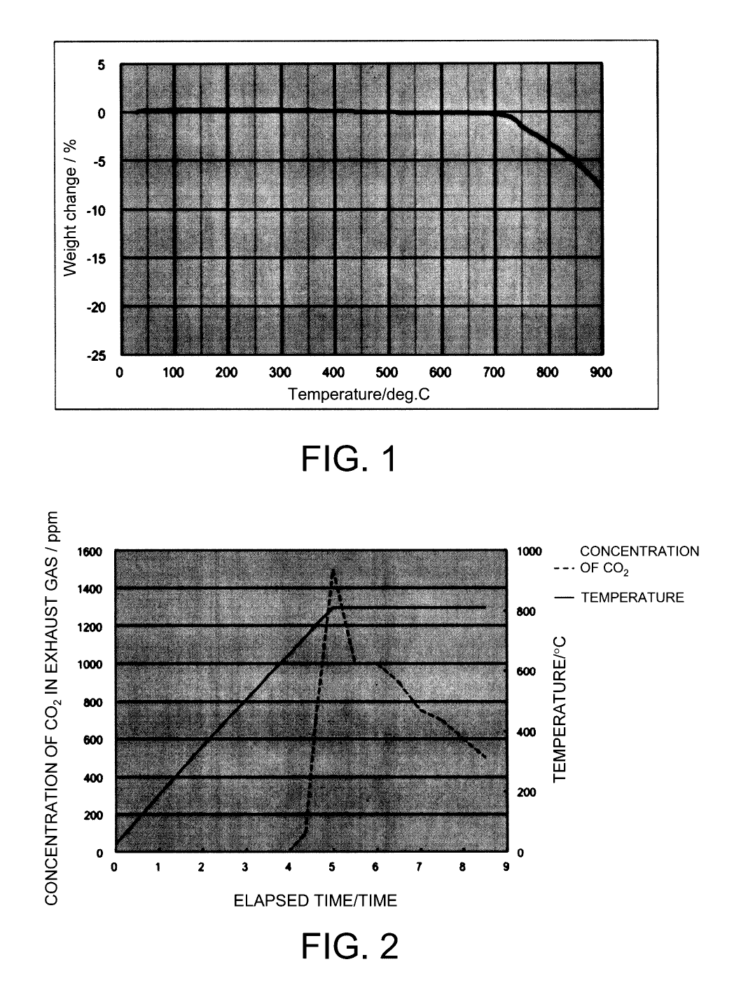

### BEST MODE FOR CARRYING OUT THE INVENTION

A nickel-lithium metal composite oxide represented by the following Formula (1) is obtained with a preparation method of the invention. In Formula (1), M represents metal elements which include Al as an essential element and may include a metal selected from Mn, W, Nb, Mg, Zr, and Zn. The amount of one or more kinds of the metal selected from Mn, W, Nb, Mg, Zr, and Zn which are arbitrary constituent elements may be arbitrarily set, as long as it is in a range not disturbing a function of the nickel-lithium metal composite oxide represented by the following Formula (1) as a nickel-based positive electrode active material.

The supplying of one or more kinds of the metal selected from Mn, W, Nb, Mg, Zr, and Zn to the nickel-lithium metal composite oxide may be performed in any steps of the preparation method of the invention. For example, the metal may be supplied as impurities contained in the raw material, may be supplied as auxiliary components in the following Step 1 or Step 1′ which is the essential step, or may be supplied in any step.

LiₐNi_{1-x-y}COₓM_{y}O_{b} (1)
(here, in Formula (1), relationships of 0.90<a<1.10, 1.7<b<2.2, 0.01<x<0.15, and 0.005<y<0.10 are satisfied and M represents Al or Al containing the small amount of one or more kinds of metals selected from Mn, W, Nb, Mg, Zr, and Zn.)

In the invention, first, raw materials of the metals configuring the nickel-lithium metal composite oxide are mixed with each other in Step 1 and/or Step 1′. The obtained mixture is fired at a low temperature range lower than the melting point of the lithium carbonate in Step 2 and further fired at a high temperature range higher than the melting point of the carbonate lithium in Step 3, to obtain a desired nickel-lithium metal composite oxide. Hereinafter, each step of the preparation method of the invention will be described. An example in which M in Formula (1) is Al is used, in order to briefly describing the operations in each step and chemical reactions occurring in each step. A preparation method in a case where M in Formula (1) contains metals other than Al is based on this example.

(Step 1) This is a mixing step of mixing a hydroxide of a metal M and/or an oxide of the metal M and lithium carbonate, with a precursor including a nickel hydroxide and/or a nickel oxide and a cobalt hydroxide and/or a cobalt oxide. The lithium carbonate is a raw material of the lithium hydroxide (normally, lithium hydroxide monohydrate). As described above, in the technology of the related art, the lithium hydroxide was used as a raw material of the nickel-lithium metal composite oxide. When comparing the cost per unit weight, the lithium carbonate is more inexpensive than the lithium hydroxide, and when comparing the content of lithium per unit weight, the lithium carbonate contains lithium with higher concentration than that of lithium hydroxide monohydrate, and accordingly, the lithium carbonate is effectively used. The mixing is performed by applying a shear force by using various mixers.

(Step 1′) This is a mixing step of mixing lithium carbonate, with a precursor including a nickel hydroxide and/or a nickel oxide, a cobalt hydroxide and/or a cobalt oxide, and a hydroxide of a metal M and/or an oxide of the metal M. As described in Step 1, it is advantageous to use the lithium carbonate from a viewpoint of the manufacturing costs. The mixing is performed by applying a shear force by using various mixers.

The raw material mixture obtained in the mixing step of the invention is used in the following Step 2. A firing material used in Step 2 may be only the mixture prepared in Step 1, may be only the mixture prepared in Step 1′, or may be a material obtained by further mixing the mixture prepared in Step 1 and the mixture prepared in Step 1′ with each other.

(Step 2) This is a low-temperature firing step of firing the mixture obtained in Step 1 or 1′ in a temperature range lower than 723° C. which is a melting point of the lithium carbonate, preferably in a temperature range of equal to or higher than 400° C. and lower than 723° C., and more preferably in a temperature range of equal to or higher than 550° C. and lower than 723° C. It is preferable to perform the firing of Step 2 under the presence of oxygen. As a firing atmosphere gas, pure oxygen, air, mixed gas obtained by adding oxygen into air, or gas obtained by adding oxygen into inert gas such as nitrogen or the like can be used. The firing time in Step 2 is normally 3 to 40 hours and preferably 5 to 35 hours.

The lithium carbonate is not melted in a temperature range of equal to or higher than 400° C. and lower than 723° C. However, pyrolysis of the lithium carbonate starts and a pyrolysate reacts with a nickel compound, a cobalt compound, and a compound of the metal M to form the nickel-lithium metal composite oxide. As described above, the lithium carbonate is used in a solid state in Step 2. Surprisingly, it is considered that substantially the entire amount of the lithium carbonate contained in the mixture obtained in Step 1 and/or Step 1′ is subjected to pyrolysis in Step 2. As described above, the lithium carbonate which is the only lithium source reacts with other raw materials to cause synthesis of the composite oxide represented by Formula (1).

The firing temperature range of Step 2 is the condition necessary for ensuring a degree of fine particles of the obtained nickel-lithium metal composite oxide. When the firing is performed at a high temperature beyond the predetermined firing temperature range, that is, a temperature range of equal to or higher than the melting point of the lithium carbonate in Step 2, the lithium carbonate is melted. The lithium carbonate remaining even after the firing becomes an adhesive which binds nickel-lithium metal composite oxide particles with each other in the cooling process to form a rigid aggregate. In a case of crushing this rigid aggregate, it is necessary to provide a significantly great crushing force in the crushing, and the excessive crushing in which even some ordinary nickel-lithium metal composite oxide particles which are not aggregated, are destructed may occur due to the strong crushing force. When the excessive crushing occurs, the normal particles are crushed and the original performance as the positive electrode active material cannot be exhibited and fine powder generated due to the excessive crushing may negatively affect battery characteristics.

(Step 3) This is a high-temperature firing step of firing the fired product obtained in Step 2 in a temperature range higher than 723° C. which is the melting point of the lithium carbonate, preferably in a temperature range of 723° C. to 850° C., and more preferably in a temperature range of 730° C. to 810° C. It is preferable to perform the firing of Step 3 under the presence of oxygen. As a firing atmosphere gas, pure oxygen, air, mixed gas obtained by adding oxygen into air, or gas obtained by adding oxygen into inert gas such as nitrogen, argon, or helium or the like can be used. The firing time in Step 3 is normally 1 to 15 hours and preferably 3 to 10 hours.

A firing furnace used in Step 2 and Step 3 is not limited as long as the firing temperature can be adjusted to be in a range suitable in Step 2 and Step 3. The firing equipment may be changed between Step 2 and Step 3. Any one of a continuous f or a batch furnace is used as such a firing furnace. A rotary kiln, a roller hearth kiln, or a muffle furnace can be used, for example.

The lithium carbonate substantially does not remain at the start of Step 3. Accordingly, melted lithium carbonate is not substantially generated in Step 3. In Step 3, crystal growth of the nickel-lithium metal composite oxide formed in Step 2 is promoted in accordance with the temperature rising. The nickel-lithium metal composite oxide useful as a positive electrode active material is obtained by performing the high-temperature firing for sufficient time in Step 3. The nickel-lithium metal composite oxide obtained from step 3 are not solidified, has excellent operatability, and exhibits excellent performance as a positive electrode active material. The performance of the nickel-lithium metal composite oxide of the invention can be confirmed with the following evaluation.

(Non-Adhesiveness of Particles)

A powder-like nickel-lithium metal composite oxide is obtained with the preparation method of the nickel-lithium metal composite oxide of the invention. In the preparation method of the nickel-lithium metal composite oxide of the invention, fine particles of lithium-nickel metal composite oxide having excellent operatabilityare already obtained immediately after Step 3. Most of the fine particles of nickel-lithium metal composite oxides passes through a standard sieve having a nominal opening size of 1.00 mm defined based on JIS Z 8801-1:2006. That is, when 100 g of the fired product obtained from Step 3 is put on a standard sieve having a nominal opening size of 1.00 mm defined based on JIS Z 8801-1:2006, the amount thereof which does not pass through is equal to or smaller than 1% by weight. The fine particles of the nickel-lithium metal composite oxide are further processed to be powder having more even and smaller particle sizes and a high proportion of particles passing through the standard sieve, through a crushing step and a sieving step which are arbitrarily provided in the preparation method of the nickel-lithium metal composite oxide of the invention and will be described later.

(Low Alkalinity)

A concentration of hydrogen ions in a supernatant when 2 g of the nickel-lithium metal composite oxide of the invention is dispersed in 100 g of water is equal to or smaller than 11.65 in terms of pH. Such a nickel-lithium metal composite oxide having low alkalinity has low reactivity with PVDF contained in a slurry of a lithium ion battery positive electrode material as a binder. Therefore, in a case where the nickel-lithium metal composite oxide of the invention is used as the positive electrode active material, the gelation of the slurry of the positive electrode material at the time of preparing a positive electrode is difficult to occur and problems in a coating step are difficult to be generated.

(Discharge Capacity)

A 0.1 C discharge capacity of a lithium ion battery including a positive electrode prepared by coating and drying a positive electrode active material mixture obtained by blending the nickel-lithium metal composite oxide powder of the invention, carbon black, and a binder such as PVDF, and a negative electrode formed of lithium metal is equal to or greater than 180 mAh/g.

(Charging and Discharging Characteristics)

An initial charging and discharging efficiency of a lithium ion battery including a positive electrode prepared by coating and drying a positive electrode active material obtained by blending the nickel-lithium metal composite oxide powder of the invention, carbon black, and a binder such as PVDF, and a negative electrode formed of lithium metal is equal to or greater than 83%.

A step of crushing the fired product obtained in Step 3 by using a ball mill, a jet mill, or a mortar can be provided after Step 3. A step of sieving the fired product particles obtained in Step 3 can also be provided after Step 3. Both of the crushing step and the sieving step may be performed. Through the crushing step and/or the sieving step, it is possible to prepare fine particles of a nickel-lithium metal composite oxide in which filling properties or a particle size distribution is adjusted. A median diameter of the nickel-lithium metal composite oxide of the invention is finally adjusted to be preferably equal to or smaller than 20 μm and more preferably 3 to 15 μm.

A nickel-lithium metal composite oxide which is suitable as a positive electrode active material of a lithium ion battery and in which fine powder is hardly generated at the time of the crushing is obtained at a low cost in the invention. The positive electrode active material of the lithium ion battery may be configured with only the nickel-lithium metal composite oxide of the invention or other positive electrode active materials for a lithium ion secondary battery may be mixed with the nickel-lithium metal composite oxide of the invention. For example, a material obtained by mixing 50 parts by weight of the nickel-lithium metal composite oxide powder of the invention and 50 parts by weight of a positive electrode active material for a lithium ion secondary battery other than the material used in the invention with each other can be used as a positive electrode active material. In a case of preparing a positive electrode of a lithium ion secondary battery, a slurry of a mixture for a positive electrode is prepared by adding a positive electrode active material containing the nickel-lithium metal composite oxide powder of the invention, a conductive assistant, a binder, and an organic solvent for dispersion and coating the slurry onto the electrode to prepare a positive electrode for a lithium ion secondary battery.

### EXAMPLES

### Example 1

A nickel-lithium metal composite oxide of the invention was prepared through the following Step 1, Step 2, and Step 3.

(Step 1) A aluminum hydroxide and lithium carbonate were mixed with a precursor having an average particle diameter of 13.6 μm which is configured with a nickel hydroxide and a cobalt hydroxide prepared from an aqueous solution of a nickel sulfate and a cobalt sulfate, with a mixer by applying a shear force. The aluminum hydroxide was prepared so that the amount of aluminum with respect to the amount of the precursor becomes 2 mol % and the lithium carbonate was prepared so that a molar ratio thereof with respect to the total nickel-cobalt-aluminum becomes 1.025, respectively.

(Step 2) The mixture obtained in Step 1 was fired at 690° C. in dry oxygen for 35 hours.

(Step 3) The fired product obtained from Step 2 was further fired at 810° C. in dry oxygen for 5 hours.

By doing so, the nickel-lithium metal composite oxide of the invention was obtained.

### Example 2

A nickel-lithium metal composite oxide of the invention was prepared through the following Step 1, Step 2, and Step 3.

(Step 1) The step was performed in the same manner as in Example 1.

(Step 2) The mixture obtained in Step 1 was fired at 690° C. in dry oxygen for 10 hours.

(Step 3) The step was performed in the same manner as in Example 1.

### Example 3

A nickel-lithium metal composite oxide of the invention was prepared through the following Step 1′, Step 2, and Step 3.

(Step 1′) Lithium carbonate was mixed with a precursor (average particle diameter of 12.7 μm) configured with a nickel hydroxide, a cobalt hydroxide, and an aluminum hydroxide prepared from an aqueous solution of a nickel sulfate, a cobalt sulfate, and an aluminum sulfate, with a mixer by applying a shear force.

(Step 2) The mixture obtained in Step 1 was fired at 690° C. in dry oxygen for 10 hours.

(Step 3) The step was performed in the same manner as in Example 1.

### Example 4

A nickel-lithium metal composite oxide of the invention was prepared through the following Step 1, Step 2, and Step 3.

(Step 1) The step was performed in the same manner as in Example 1.

(Step 2) The mixture obtained in Step 1 was fired at 690° C. in dry oxygen for 10 hours.

(Step 3) The fired product obtained from Step 2 was further fired at 780° C. in dry oxygen for 10 hours.

### Comparative Example 1

This is an example in which Step 2 of the invention is not performed. A nickel-lithium metal composite oxide was prepared through the following steps.

(Step 1) A aluminum hydroxide and lithium carbonate were mixed with a precursor having an average particle diameter of 13.6 μm which is configured with a nickel hydroxide and a cobalt hydroxide prepared from an aqueous solution of a nickel sulfate and a cobalt sulfate, with a mixer by applying a shear force. The aluminum hydroxide was prepared so that the amount of aluminum with respect to the amount of the precursor becomes 2 mol % and the lithium carbonate was prepared so that a molar ratio thereof with respect to the total nickel-cobalt-aluminum becomes 1.025, respectively.

(Firing Step) the mixture obtained in Step 1 was fired at 810° C. in dry oxygen for 10 hours.

### Comparative Example 2

This is an example in which Step 3 of the invention is not performed. A nickel-lithium metal composite oxide was prepared through the following steps.

(Step 1) A aluminum hydroxide and lithium carbonate were mixed with a precursor having an average particle diameter of 13.6 μm which is configured with a nickel hydroxide and a cobalt hydroxide prepared from an aqueous solution of a nickel sulfate and a cobalt sulfate, with a mixer by applying a shear force. The aluminum hydroxide was prepared so that the amount of aluminum with respect to the amount of the precursor becomes 2 mol % and the lithium carbonate was prepared so that a molar ratio thereof with respect to the total nickel-cobalt-aluminum becomes 1.025, respectively.

(Firing Step) the mixture obtained in Step 1 was fired at 690° C. in dry oxygen for 35 hours. Here, the firing was completed.

The nickel-lithium metal composite oxides obtained in the examples and the comparative examples were evaluated with the following criteria. Evaluation results are shown in Table 1.

(Non-Adhesiveness of Particles)

60 g of the fired product obtained from the firing step (in the examples, Step 3) was put on the standard sieve having a nominal opening size of 1.00 mm defined based on JIS Z 8801-1:2006, without performing treatment such as crushing or pulverizing. A proportion (% by weight) of the fired product remaining on the sieve with respect to the total sieved amount was measured.

(pH at 25° C.)

2 g of the obtained nickel-lithium metal composite oxide was dispersed in 100 ml of water at 25° C. and stirred with a magnetic stirrer for 3 minutes and vacuum filtration was performed. A concentration (pH) of hydrogen ions in a filtrate was measured.

(Elution Amount of Lithium Hydroxide and Lithium Carbonate)

2 g of the obtained nickel-lithium metal composite oxide was dispersed in 100 ml of water at 25° C. and stirred with a magnetic stirrer for 3 minutes and vacuum filtration was performed. Some parts of a filtrate was extracted and the elution amount of a lithium hydroxide and lithium carbonate was measured by using a Warder method. The elution amount is shown as a percentage by weight thereof in the original nickel-lithium metal composite oxide.

(Average Particle Diameter)

The obtained nickel-lithium metal composite oxide was caused to pass through the standard sieve having a nominal opening size of 53 μm defined based on JIS Z 8801-1:2006. Here, in a case without aggregation between particles, the nickel-lithium metal composite oxide was put on the sieve as it is, and in a case where the aggregation between particles is observed, the nickel-lithium metal composite oxide is crushed with a mortar and then put on the sieve. An average particle diameter (D50) of the nickel-lithium metal composite oxide particles passed through the sieve was measured by using a laser scattering-type particle size distribution measuring device LA-950 manufactured by Horiba, Ltd.

(Battery Characteristics)

The preparation was performed so that 1 part by weight of ACETYLENE BLACK manufactured by Denka Company Limited, 5 parts by weight of graphite carbon manufactured by Nippon Kokuen Group, and 4 parts by weight of Polyvinylidene fluoride manufactured by Kureha Corporation are obtained with respect to 100 parts by weight of the obtained nickel-lithium metal composite oxide and a slurry was prepared by using N-methylpyrrolidone as a dispersing solvent. This slurry was applied on an aluminum foil which is a collector, and dried and pressed to obtain a positive electrode, and a negative electrode with lithium metal foil on a counter electrode to prepare a 2032 type coin battery. The 0.1 C discharge capacity and the initial efficiency of this battery were measured.

TABLE 1

| | | | Amount remaining | | Average | | | | 0.1 C | |
|---|---|---|---|---|---|---|---|---|---|---|
| | Step 2 | Step 3 | on 1.00 mm | | particle | | LiOH | Li₂CO₃ | discharge | |
| | Temperature | Temperature | standard sieve | Mortar | diameter | pH | (% by | (% by | capacity | Initial |
| | Time | Time | (% by weight) | crushing | D50 (μm) | (25° C.) | weight) | weight) | (mAh/g) | efficiency |
| Example 1 | 690° C. | 810° C. | 0 | Not | 16.1 | 11.69 | 0.60 | 0.21 | 195 | 90% |
| | 35 hours | 5 hours | | performed | | | | | | |
| Example 2 | 690° C. | 810° C. | 0 | Not | 18.3 | 11.65 | 0.58 | 0.62 | 194 | 90% |
| | 10 hours | 5 hours | | performed | | | | | | |
| Example 3 | 690° C. | 810° C. | 0 | Not | 15.5 | 11.41 | 0.41 | 0.37 | 193 | 89% |
| | 10 hours | 5 hours | | performed | | | | | | |
| Example 4 | 690° C. | 780° C. | 0 | Not | 17.8 | 11.39 | 0.34 | 0.26 | 195 | 90% |
| | 10 hours | 10 hours | | performed | | | | | | |
| Comparative | — | 810° C. | 99.5 | Performed | 23.9 | 11.82 | 0.99 | 0.94 | 187 | 89% |
| Example 1 | | 10 hours | | | | | | | | |
| Comparative | 690° C. | — | 0 | Not | 14.8 | 11.66 | 0.62 | 0.20 | 173 | 89% |
| Example 2 | 35 hours | | | performed | | | | | | |

The total amounts of the nickel-lithium metal composite oxides of Examples 1 to 4 pass through the standard sieve having nominal opening size of 1.00 mm and the nickel-lithium metal composite oxides have a granular shape. These particles passed through the standard sieve having nominal opening size of 53 μm, without being further crushed with a mortar. The average particle diameters of the nickel-lithium metal composite oxides of Examples 1 to 4 are close to the average particle diameter (13.6 μm or 12.7 μm) of the precursor used in Step 1 or Step 1′. As described above, in the nickel-lithium metal composite oxides of Examples 1 to 4, the particles are not aggregated and the crushing with a strong force is not necessary for obtaining an even dispersing slurry.

With respect to this, since the nickel-lithium metal composite oxide of Comparative Example 1 is formed in a lump shape, the total amount thereof substantially did not pass through the standard sieve having nominal opening size of 1.00 mm. Even when these particles are crushed with a mortar, the average particle diameter (23.9 μm) thereof is fairly greater than the average particle diameter (13.6 μm) of the precursor used in Step 1, and thus the particles are rigidly attached to each other. In addition, the nickel-lithium metal composite oxide of Comparative Example 1 is also inferior to the nickel-lithium metal composite oxide of Example 1, in terms of low alkalinity and charging and discharging characteristics.

The nickel-lithium metal composite oxide of Comparative Example 2 has granular shape, but is inferior to the nickel-lithium metal composite oxide of Example 1, in terms of charging and discharging characteristics.

As described above, the nickel-lithium metal composite oxide of the invention has low aggregation properties, low alkalinity, and charging and discharging characteristics in good balance. Such performances in balance cannot be achieved by using a preparation method other than the method of the invention, for example, a method using different firing conditions.

### FIELD OF INDUSTRIAL APPLICATION

The invention is advantageous as means for providing a lithium ion battery exhibiting high performance at a low cost. The nickel-lithium metal composite oxide obtained in the invention and the lithium ion battery using this contribute further reduction in cost of a portable information terminal or a vehicle mounted with a battery.

1. A preparation method of a nickel-lithium metal composite oxide represented by the following Formula (1), comprising the following Step 1 and/or Step 1′, Step 2, and Step 3, in which lithium carbonate is used as a lithium source:
Step 1: a mixing step of mixing a hydroxide of a metal M and/or an oxide of the metal M and lithium carbonate, with a precursor including a nickel hydroxide and/or a nickel oxide and a cobalt hydroxide and/or a cobalt oxide to obtain a mixture;
Step 1′: a mixing step of mixing lithium carbonate, with a precursor including a nickel hydroxide and/or a nickel oxide, a cobalt hydroxide and/or a cobalt oxide, and a hydroxide of a metal M and/or an oxide of the metal M to obtain a mixture;
Step 2: a low-temperature firing step of firing the mixture obtained in Step 1 and/or Step 1′ at a temperature lower than a melting point of lithium carbonate to obtain a first fired product;
Step 3: a high-temperature firing step of firing the first fired product passed through Step 2 at a temperature equal to or higher than a melting point of lithium carbonate to obtain a second fired product;
LiₐNi_{1-x-y}CoₓM_{y}O_{b} (1)
in Formula (1), relationships of 0.90<a<1.10, 1.7<b<2.2, 0.01<x<0.15, and 0.005<y<0.10 are satisfied, M represents metals which include Al as an essential element and may include elements selected from Mn, W, Nb, Mg, Zr, and Zn.

2. The preparation method of a nickel-lithium metal composite oxide according to claim 1,
wherein the firing is performed in a temperature range of equal to or higher than 400° C. and lower than 723° C. in Step 2, and
the firing is performed in a temperature range of 723° C. to 850° C. in Step 3.

3. The preparation method of a nickel-lithium metal composite oxide according to claim 1,
wherein a continuous furnace or a batch furnace is used in Step 2 and/or Step 3.

4. The preparation method of a nickel-lithium metal composite oxide according to claim 3,
wherein a firing furnace selected from a rotary kiln, a roller hearth kiln, and a muffle furnace is used in Step 2 and/or Step 3.

5. The preparation method of a nickel-lithium metal composite oxide according to claim 1,
wherein a nickel-lithium metal composite oxide fired product, an amount of which does not pass through a standard sieve having a nominal opening size of 1.00 mm defined based on JIS Z 8801-1:2006 is equal to or smaller than 1% by weight, is obtained from Step 3.

6. The preparation method of a nickel-lithium metal composite oxide according to claim 1, further comprising:
a step of crushing the second fired product obtained in Step 3 and/or a step of sieving the second fired product passed through Step 3, after Step 3.

7. A nickel-lithium metal composite oxide powder which is a nickel-lithium metal composite oxide powder represented by the following Formula (1),
LiₐNi_{1-x-y}CoₓM_{y}O_{b} (1)
in Formula (1), relationships of 0.90<a<1.10, 1.7<b<2.2, 0.01<x<0.15, and 0.005<y<0.10 are satisfied, M represents metals which include Al as an essential element and may include elements selected from Mn, W, Nb, Mg, Zr, and Zn;
wherein the nickel-lithium metal composite oxide powder functions as a lithium ion battery positive electrode active material,
in which an amount of the nickel-lithium metal composite oxide powder not passed a standard sieve having a nominal opening size of 1.00 mm defined based on JIS Z 8801-1:2006 is equal to or smaller than 1% by weight,
a concentration of hydrogen ions in a supernatant when 2 g of the nickel-lithium metal composite oxide powder is dispersed in 100 g of water is equal to or smaller than 11.70 in terms of pH,
a 0.1 C discharge capacity of a lithium ion battery including a positive electrode including a coating film dried product from a positive electrode active material mixture containing the nickel-lithium metal composite oxide powder, carbon black, and a binder, and a negative electrode formed of lithium metal is equal to or greater than 180 mAh/g, and
an initial charging and discharging efficiency of a lithium ion battery including a positive electrode including a coating film dried product from a positive electrode active material mixture containing the nickel-lithium metal composite oxide powder, carbon black, and a binder, and a negative electrode formed of lithium metal is equal to or greater than 83%.

8. The nickel-lithium metal composite oxide powder according to claim 7, which is a powder immediately after performing the firing, without performing either of a crushing treatment with a pulverizing device or a crushing device and sieving.

9. The nickel-lithium metal composite oxide powder according to claim 7, which is a material obtained by using a preparation method of a nickel-lithium metal composite oxide represented by the following Formula (1), comprising the following Step 1 and/or Step 1′, Step 2, and Step 3, in which lithium carbonate is used as a lithium source:
Step 1: a mixing step of mixing a hydroxide of a metal M and/or an oxide of the metal M and lithium carbonate, with a precursor including a nickel hydroxide and/or a nickel oxide and a cobalt hydroxide and/or a cobalt oxide to obtain a mixture;
Step 1′: a mixing step of mixing lithium carbonate, with a precursor including a nickel hydroxide and/or a nickel oxide, a cobalt hydroxide and/or a cobalt oxide, and a hydroxide of a metal M and/or an oxide of the metal M to obtain a mixture;
Step 2: a low-temperature firing step of firing the mixture obtained in Step 1 and/or Step 1′ at a temperature lower than a melting point of lithium carbonate to obtain a first fired product;
Step 3: a high-temperature firing step of firing the first fired product passed through Step 2 at a temperature equal to or higher than a melting point of lithium carbonate to obtain a second fired product;
LiₐNi_{1-x-y}CoₓM_{y}O_{b} (1)
in Formula (1), relationships of 0.90<a<1.10, 1.7<b<2.2, 0.01<x<0.15, and 0.005<y<0.10 are satisfied, M represents metals which include Al as an essential element and may include elements selected from Mn, W, Nb, Mg, Zr, and Zn.

10. A positive electrode active material comprising:
the nickel-lithium metal composite oxide powder according to claim 8.

11. A positive electrode mixture for a lithium ion battery comprising:
the positive electrode active material according to claim 10.

12. A positive electrode for a lithium ion battery using the positive electrode mixture for a lithium ion battery according to claim 11.

13. A lithium ion battery comprising:
the positive electrode for a lithium ion battery according to claim 12.
